(19) United States
(12) Patent Application Publication
(10) Pub. No.: US 2008/0015756 A1
(43) Pub. Date: Jan. 17, 2008

(54) Track-Guided Transport System

(76) Inventor: Josef Schmidt, Graben-Neudorf (DE)

Correspondence Address: KENYON & KENYON LLP, ONE BROADWAY, NEW YORK, NY, 10004, US

(21) Appl. No.: 11/631,203

(22) PCT Filed: May 12, 2005
(86) PCT No.: PCT/EP05/05137

§ 371 Date: Sep. 24, 2007

(30) Foreign Application Priority Data
Jun. 29, 2004 (DE) 102004031581.7

(51) Int. Cl. G06F 19/00

(52) U.S. Cl. 701/50; 701/200

(57) ABSTRACT

A track-guided transport system having at least one track made up of bearing and track-guidance elements on which at least one transport vehicle is guided as main vehicle, which has device(s) for self-automated movement along the track, and to which energy is transmitted from a primary circuit which has a contact wire and is installed along the track, or in a contactless manner, the main vehicle including a lifting platform which is able to be driven by a drive, for example, an electric motor or gear motor, and on which there is at least one satellite vehicle which has a drive such as an electric motor or gear motor, for self-automated movement along an additional track, and which is configured for the transportation of goods, the track including a satellite track section for positioning and parking the satellite vehicle, the satellite track section being able to be brought into flush alignment by positioning the main vehicle on satellite tracks disposed along its track, perpendicular thereto, these satellite tracks being disposed on shelves, the satellite track sections and satellite tracks including primary conductors, which are contactlessly supplied with energy from the main vehicle, currents modulated upon the primary lines and/or the primary circuit to a higher frequency, e.g., a medium frequency, being provided for the contactless transmission of information between a fixed station, a carrier vehicle and/or a satellite vehicle.

### FIELD OF THE INVENTION

The present invention relates to a track-guided transport system.

### BACKGROUND INFORMATION

German Published Patent Application No. 197 35 624 describes a method for contactless energy transmission of electric power via a transmission path, from a medium-frequency power source having a medium frequency f_{M} to one or more mobile consumers, and from the transmission heads, allocated to the mobile consumers, having a downstream adapter for adjusting the power taken up from the transmission path, the medium-frequency power source supplying the transmission path with a medium frequency current whose effective value remains constant during the power transmission.

The medium-frequency current injected from the transmission head is converted into a DC voltage by the adapter. As described in FIGS. 3, 7a and 7b and the associated text of German Published Patent Application No. 197 35 624, switch T_{S} is operated in synchrony with the input current characteristic, and with double the frequency of the input current of the adapter. However, a considerable disadvantage is that this high switching frequency 2 f_{M} results in high switching losses. An additional disadvantage is that the synchronous principle can no longer be maintained when a plurality of asynchronously operating power supplies is used to supply an adapter.

German Published Patent Application No. 100 53 373 describes a method which, in contrast to German Published Patent Application No. 197 35 624, is operated asynchronously and has lower switching losses.

German Published Patent Application No. 33 42 184 describes a conveyor device which includes guide tracks and has cornering ability with forced steering.

German Published Patent Application No. 198 49 276 describes a method for traveling a path using a stacker crane, having cornering ability, for a shelf-storage system. Such systems are supplied by a contact wire, which is not wear-resistant.

From the Web page http://www.sew-eurodrive.de/deutsch/03_produkte/index_produkte .htm, shelf storage systems and associated shelf operating devices are described.

System components are also described in the flyer of the company SEW-EURODRIVE GmbH & Co. KG, “Produktankündigung, MOVITRANS” (“Product Announcement, MOVITRANS”). The transmission head is referred to as a pick-up and is connected to an adapter, which provides a supply voltage for a consumer.

German Published Patent Application No. 196 26 966 describes a transport system having satellite vehicles in which the main vehicle is supplied with energy in a contactless manner. Moreover, the satellite vehicles are contactlessly supplied with energy. In this case, it is disadvantageous that the satellite vehicle has a large overall height because of the space required for the U-shaped transmission heads. Furthermore, primary circuits such as line conductors, which need a constant current supply, are installed both in the main track and also in the side aisles or shelves. The radiation losses are high as a result.

E-shaped planar cores are described in the prospectus brochure Planar E-Kerne für SMPS (Planar E-Cores for SMPS), i.e., switch mode power supplies, of the firm Kaschke KG dating from the year 2003.

European Published Patent Application No. 0 961 743 describes a transport system where, according to column 6, paragraph [0020], information is transmitted via radio between a fixed station, a satellite vehicle and a carrier vehicle. However, it is disadvantageous that the radio transmission can be utilized only if there are no reflections or dead sectors for the radio waves. A slotted coaxial cable is proposed as an alternative, which is complicated and costly when installed within the system. In addition, the necessary patch antenna requires space.

### SUMMARY

Example embodiments of the present invention provide a shelf storage system and an associated shelf operating device that allow excellent control, are cost-effective and have a compact design.

The transport system may include at least one track, made up of bearing and track-guidance elements, on which at least one transport vehicle is guided as main vehicle, which is arranged for self-automated movement along the track and to which energy is transmitted from a primary circuit that is installed along the track and includes a contact wire, or in a contactless manner, the main vehicle including a lifting platform which is able to be driven by a drive, especially, for example, an electric motor or gear motor, and on which there is at least one satellite vehicle that also includes a drive such as an electric motor or gear motor, for self-automated movement along an additional track, and which is configured for the transportation of goods, the track including a satellite track section for positioning and parking the satellite vehicle, the satellite track section being able to be brought into alignment by positioning the main vehicle on satellite tracks disposed along its track, perpendicular thereto, these satellite tracks being disposed on shelves, the satellite track sections and satellite tracks including primary conductors, which are contactlessly supplied with energy from the main vehicle.

Less wiring may thus be required, the radiation may be reduced, the outlay in connection with distribution boxes and associated electrical and electronic components may be lowered, and the cost may be reduced. Besides that, the transport system has a compact design. By utilizing the information transmission, the central station has excellent control of the shelf operating device because it is able to exchange information with the satellite vehicle and may also process information from sensors and actuators of this or other component(s). No coaxial cable may be required in the track. Regardless of the system's geometry, the information may be able to be transmitted in a reliable manner inasmuch as the modulated-upon currents are substantially unaffected by the objects in the environment, in contrast to a radio transmission.

Additional stationary or mobile components may be able to be inductively coupled to the primary components, so that data may be exchanged with these components as well. That is to say, a special bus system may be provided for a transport system in which the bus participants are able to exchange data in a contactless manner via the primary components, i.e., the provided medium-frequency energy distribution system.

The drive of the lifting platform may be contactlessly supplied with energy. The drive of the satellite vehicle, in particular, is supplied with energy in a contactless manner. This may provide for reducing the wear and the maintenance expenditure.

In at least one location, energy may be able to be contactlessly supplied from the main vehicle to at least one primary conductor of at least one shelf of at least one side aisle. It may be provided that only the particular shelf or shelves is/are energized in which the satellite vehicle is located. There is no need to energize other primary lines. No electrical distribution devices are therefore necessary. In addition, the radiation and the costs are able to be reduced.

At least one transmission head may be provided for the contactless transmission of energy. It may be provided that a compact design is achievable and/or a high degree of efficiency.

The main vehicle may include a power supply which feeds a primary line provided on the main vehicle, which is inductively coupled to a transmission head connected to a terminal box for impedance compensation, the terminal box supplying at least one primary line provided in the satellite track section. It may be provided that the impedance is adaptable to the application.

The main vehicle may have a primary line, which, during the alignment, is able to be inductively coupled to a transmission head installed in the floor, which is connected to at least one primary line provided in a shelf, via a terminal box for impedance compensation. It may be provided that the position of the main vehicle controls the energizing of the primary conductors of the shelves. No further distribution devices are therefore required.

The lifting platform may include a primary line, e.g., a transmission head provided as primary line, which, during the flush alignment of the main vehicle and vertical positioning of the lifting platform, is able to be inductively coupled to a transmission head provided on the shelf, the transmission head being connected to at least one primary line provided in a shelf, via a terminal box for impedance compensation. For example, the energizing of the primary conductor of the respective shelf is implemented via the main vehicle. It may be provided that the positioning of the main vehicle and the lifting platform controls the energizing of the primary conductors of the shelves.

At least one transmission head may have a U-shaped or C-shaped or E-shaped ferrite core. This may provide for allowing a high degree of efficiency to be attained.

At least one transmission head may include a winding in the form of a flat winding. It may be provided that a very compact design is able to be achieved for the shelf storage system including the main vehicle and satellite vehicle.

The flat winding may be disposed around the middle leg of an E-shaped core. This may provide that, notwithstanding the flat winding, high efficiency is able to be achieved in the contactless transmission of energy.

The legs of the E may be shorter than the mutual distance of the next nearest legs. This may provide for a very compact design.

The primary line may be configured as feed and return line, or as feed line and an at least partially surrounding profile.

This may provide that the system of contactless energy transmission is adaptable to the application.

Example embodiments of the present invention are described in greater detail below with reference to the appended figures.

### BRIEF DESCRIPTION OF THE DRAWINGS

FIG. 1 illustrates a shelf storage system and associated operating device according to an example embodiment of the present invention.

FIG. 2 is a schematic top view of an example embodiment of the present invention.

FIG. 3 is a schematic circuit diagram of an electronics system.

FIG. 4 illustrates a shelf storage system and associated operating device according to an example embodiment of the present invention.

FIG. 5 is a cross-sectional view of a transmission head.

### DETAILED DESCRIPTION

Example embodiments of the present invention include systems for the contactless transmission of energy. In particular, a transmission head having at least one winding is provided on the mobile component. The non-mobile component of the system includes as a primary line at least one line conductor and a return line. The return line may be implemented either in a profile or as line conductor as well. The transmission head is inductively coupled to the line conductor(s). If the return line is implemented in a profile, the transmission head is arranged such that at least its ferrite core at least partially surrounds the line-type feed line. Accordingly, the transmission head has a U-shaped or C-shaped arrangement. The secondary winding, that is, the winding of the transmission head, is guided around the legs of the U or C. If the return line is implemented as line conductor, the ferrite core may be arranged as E-shaped core, and the two lines, i.e., the feed line and the return line, are situated between the legs of the E, or at a slight distance from this position in the direction of the legs.

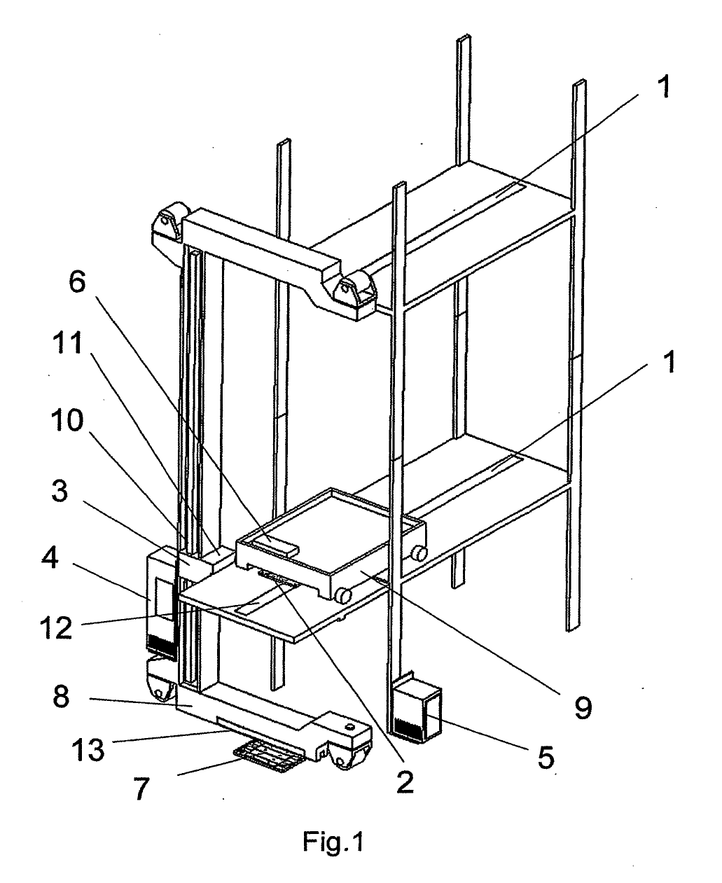

A shelf storage system and associated shelf operating device according to an example embodiment of the present invention are illustrated in FIG. 1.

The shelf operating device includes a main vehicle 8 on which a satellite vehicle 9 is provided, which a lifting platform is able move vertically to a shelf of the shelf storage system with the aid of a drive. The shelf storage system has two shelves in FIG. 1.

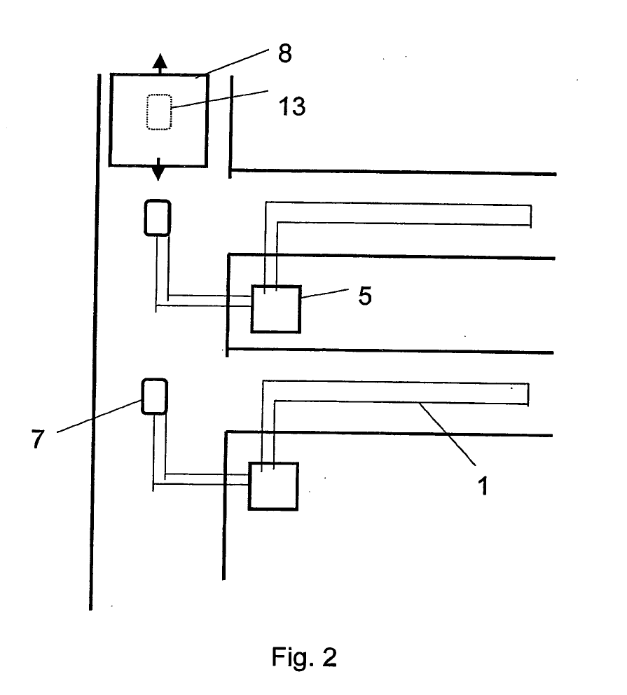

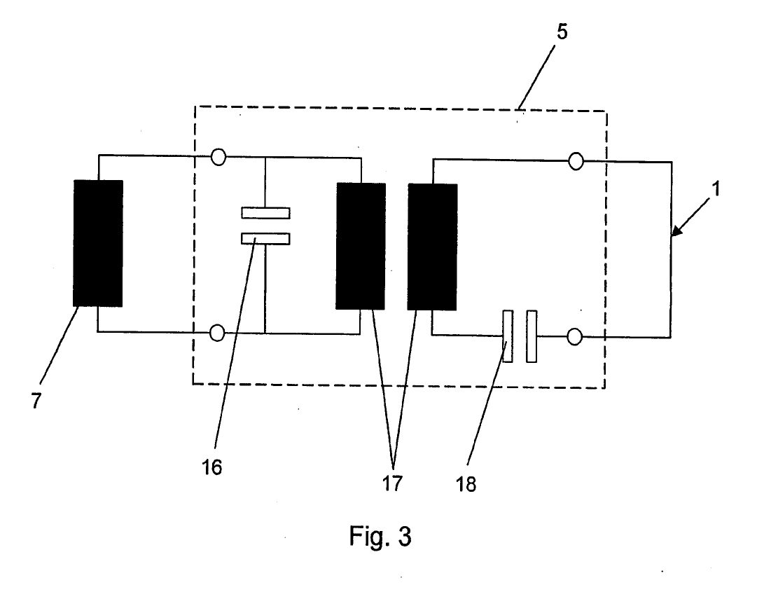

The shelves are situated one over the other in a side aisle. Additional side aisles are schematically illustrated in FIG. 2. FIG. 2 also illustrates, as a primary line, line conductor 1, which is installed in a shelf and has a feed and return line, this primary line being electrically connected to a terminal box 5, which is connected to a flat transmission head 7 fixedly disposed in the base. Terminal box 5 includes an electronics system for impedance adaptation, which is illustrated in FIG. 3 by way of example. Additional exemplary embodiments may also have similarly configured circuits that include the functions of FIG. 3 as a minimum.

As illustrated in FIG. 1, a line conductor is provided on the lifting platform, which, once the correct height of the shelf of the shelf storage system has been attained, is disposed such that line conductor 1 located in the side aisle is in alignment with the line conductor of the lifting platform. This allows a contactless supply of energy of the satellite vehicle, e.g., when maneuvering the lifting platform into and out of the shelf.

Satellite vehicle 9 includes a flat transmission head 2 for energy pick-up. Moreover, satellite vehicle 9 has a vehicle control system which is supplied via transmission head 2 and an electronic circuit, which is electrically connected thereto and also referred to as adapter. In additional exemplary embodiments, these components may also have an integratable configuration and in that case may require less space. A housing, e.g., may be provided for the integrated development, so that the mass may be reduced, which increases the dynamic response of the vehicle.

The lifting platform is vertically movable and includes a drive for this purpose, which is contactlessly supplied from the primary line of the main vehicle. A U-shaped transmission head 3 is provided on the lifting platform for this purpose and a line conductor 10 as primary line on the main vehicle. The energy transmission therefore takes place with a high degree of efficiency. The required space for the U-shaped transmission head causes no problem since the contactless energy supply is situated at the side of the main vehicle, i.e., in the direction of movement.

The drive of the main vehicle and at least one power supply 4 are electrically supplied by contact wires. Power supply 4 supplies vertical line conductor 10 and an additional line conductor 13, which is installed horizontally on the vehicle floor of the main vehicle. This additional line conductor 13 is supplied via power supply 4 and situated such that, when line conductor 12 of the main vehicle is in alignment with line conductor 1 of the side aisle, line conductor 13 is positioned above a flat transmission head 7 installed in the floor. Thus, energy is transferable from line conductor 13 to this flat transmission head 7. Flat transmission head 7 is electrically connected to terminal box 5, which is provided for distribution to line conductors 1 of the shelves.

The satellite vehicle includes at least one flat transmission head 7 for energy pickup, which is coupled to the line conductor of the lifting platform or the shelf. Since the power supply supplies both line conductors either directly or indirectly, no substantial fluctuation in the energy supply is noticeable when the satellite vehicle is advanced from the lifting platform.

In additional exemplary embodiments, satellite vehicle 9 includes a plurality of flat transmission heads 2 for energy pickup. Depending on the requirements, it is therefore possible to transfer more energy to the mobile vehicle component.

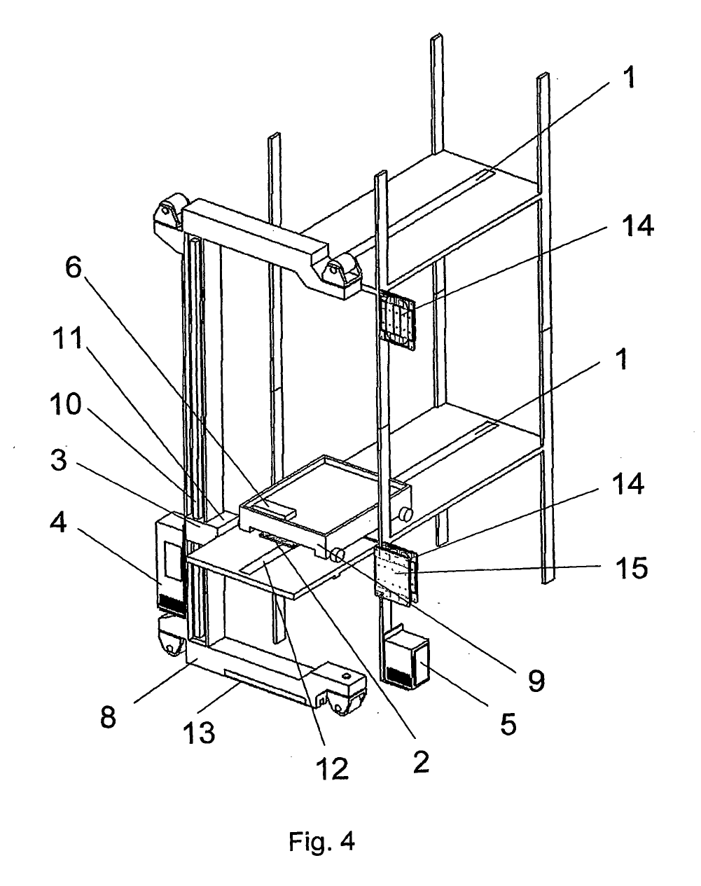

FIG. 4 illustrates an exemplary embodiment according to the present invention where a flat transmission head 15 is mounted on the lifting platform, which, when line conductor 12 of the track of the satellite vehicle of the lifting platform and line conductor 1 of the shelf are aligned, is positioned in alignment in front of a flat transmission head 14, which is fixedly connected to the shelf, electrically connected to line conductor 1 of the shelf and supplying it. Consequently, only required line conductor 1 of the respective shelf is energized, and the energy loss is minimized.

The lifting platform includes terminal box 11, which is electrically connected to U-shaped transmission head 3 and supplies line conductor 12 of the lifting platform. In the exemplary embodiment illustrated in FIG. 4, terminal box 11 additionally supplies flat transmission head 15, which is mounted on the lifting platform and supplies the respective flat transmission head 14 when in the aligned position.

FIG. 3 is a circuit diagram of terminal box 5. Via a capacitor 16, secondary winding 7 of flat transmission head 7 illustrated in FIG. 1, which is installed in the floor, is connected to the primary winding of adaptation transformer 17 in order to compensate the inductance of transmission head 7. Its secondary winding is connected in series with line conductor 1 as primary conductor via a capacitor 18 for compensation of the path, i.e., line conductor 1. As a result, the impedances are able to be optimized with the aid of capacitors 16 and 18 and with the aid of adaptation transformer 17.

In additional exemplary embodiments, instead of supplying the main vehicle by contact wire, a supply using a system of contactless energy transmission is possible as well. This makes it possible to reduce the wear as well as the maintenance costs even further.

In additional exemplary embodiments, a plurality of shelves may be provided instead of two shelves, and a plurality of lifting platforms instead of one, and a plurality of satellite vehicles instead of one as well.

In further exemplary embodiments, the use of U-shaped or C-shaped transmission heads in place of flat transmission heads is possible as well.

Example embodiments of the present invention relate not only to shelf operating devices but also to other track-guided transport systems having at least one track made up of bearing elements and track-guidance elements on which at least one transportation vehicle is guided as main vehicle, which has device(s) for self-automated movement along the track, and to which energy is transferred in a contactless manner from a primary circuit installed along the track, the main vehicle including a lifting platform able to be driven by a drive, such as an electric motor or gear motor, and on which at least one satellite vehicle is located, which includes a drive, such as an electric motor or gear motor, for self-automated movement along an additional track, and which is designed for the transportation of goods. In this context, the track of the satellite vehicle is formed by a first part that belongs to the lifting platform and may be denoted as satellite track section, and at least one further part that belongs to a shelf and may be denoted as a satellite track. A primary conductor such as a line conductor or a primary winding is provided in the track of the satellite vehicle on the one hand, i.e., in the part located on the lifting platform, and in the part located on the shelf on the other hand.

The satellite vehicle includes a transmission head which is inductively coupled to the primary conductor and therefore allows a contactless transmission of energy. The lifting platform includes a transmission head which is inductively coupled to a primary conductor, such as a line conductor or a primary winding, so that the lifting platform is able to be supplied with energy in a contactless manner. The transmission head may be arranged either in a U-shape or flat. In the flat arrangement, the transmission head includes a flat winding that is disposed around the middle leg of an E-shaped core. The legs of the E may be very short because the flat winding has only a small height in the direction of the legs of the E. The primary line is configured as feed line and return line.

The energizing of the primary conductor of the respective shelf may be implemented from the main vehicle, so that the wiring expenditure is reduced. Besides, no costly energy distribution by distributors or also controllable distribution boxes has to be provided. In a shelf storage system with a multitude of shelves, this results in very high savings in labor and expenditures.

The primary line is arranged as a long extended conductor system. Power supply 4 is configured as a medium-frequency source for supplying the connected primary lines.

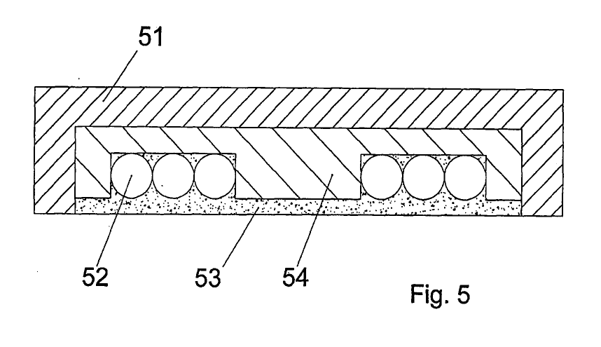

FIG. 5 schematically illustrates an exemplary flat transmission head 2, 7, 14 in cross section. An E-shaped planar core 54 is wound with a single-layer flat winding 52 encapsulated in a casting compound 53. The E-shaped planar core is partially surrounded by an aluminum plate 51. In further exemplary embodiments, it is also possible to provide multilayer flat windings instead of single-layer flat windings.

In other exemplary embodiments, identically acting transmission heads having not exactly the same but merely a similar arrangement may be used as well.

Currents modulated upon the primary conductors and/or the primary circuit as higher-frequency, e.g., as medium-frequency, may be provided for the contactless transmission of information between a fixed station, the carrier vehicle and/or the satellite vehicle. For this purpose, the fixed station, the carrier vehicle and/or the satellite vehicle are equipped with at least one coupling unit for the in- and/or out-coupling of the higher-frequency currents.

Using the primary circuit, the primary conductors and the transmission heads, it is therefore not only possible to provide the medium-frequency current for the transmission of energy, but also the current modulated-upon at a higher than medium-frequency, for data transmission. Given a medium-frequency of 15 to 30 kHz for energy transmission, a current of more than 100 kHz may be provided for the transmission of information. However, frequencies from the MHz or GHz range may be used as well, taking the dimensions, type of construction and configuration of the entire system into account.

The coupling units may be configured as predominantly inductive or predominantly capacitive units. It is possible, for instance, to electrically connect a high-pass filter at the transmission head to separate the higher-frequency current components, i.e., to separate a modulated-upon current component.

No coaxial cable may be required in the track. An additional feature is that, regardless of the system's geometry, the information is able to be transmitted in a reliable manner since, in contrast to a radio transmission, the modulated-upon currents are substantially unaffected by the objects in the environment.

No additional components may need to be provided in the track in order to realize the contactless transmission of information. The reason for this is that the transmission heads are inductively able to be coupled to the primary components and are therefore suitable also for the contactless transmission of the modulated-upon current components.

The transmission of information may be able to be carried out across a plurality of transmission heads, e.g., 3, 14, 15.

### LIST OF REFERENCE NUMERALS

1 line conductors for side aisle
2 transmission head, flat
3 transmission head, U-shaped
4 supply device
5 terminal box
6 vehicle control
7 transmission head, flat
8 main vehicle
9 satellite vehicle
10 main vehicle line conductor, vertical
11 terminal box
12 line conductor, lifting platform
13 line conductor on the main vehicle, horizontally installed in the vehicle floor
14 transmission head, flat
15 transmission head, flat
16 capacitor for compensation
17 adaptation transformer
18 capacitor for path compensation
51 aluminum plate
52 flat winding
53 casting compound
54 planar core

1-15. (canceled)

16. A track-guided transport system, comprising:
at least one transport vehicle;
at least one track including bearing and track-guidance elements on which the transport vehicle is guided as a main vehicle, the transport vehicle adapted for self-automated movement along the track;
a primary circuit adapted to transmit energy to the transport vehicle at least one of (a) by a contact wire installed along the track and (b) in a contactless manner;
wherein the main vehicle includes a lifting platform drivable by a drive, at least one satellite vehicle arranged on the lifting platform and including a drive for self-automated movement along an additional track, and which is configured to transport goods, the track including a satellite track section adapted to position and park the satellite vehicle, the satellite track section being able to be brought into flush alignment by positioning the main vehicle on satellite tracks disposed along its track, perpendicular thereto, the satellite tracks being disposed on shelves, satellite track sections and satellite tracks including primary conductors, which are contactlessly supplied with energy from the main vehicle, currents modulated upon at least one of (a) the primary conductors and (b) the primary circuit to a higher frequency provided for the contactless transmission of information between at least one of (a) a fixed station, (b) a carrier vehicle and (c) a satellite vehicle.

17. The transport system according to claim 16, wherein the drive of at least one of the (a) the lifting platform and (b) the satellite vehicle includes at least one of (a) an electric motor and (b) a gear motor.

18. The transport system according to claim 16, wherein the higher frequency is a medium frequency.

19. The transport system according to claim 16, wherein at least one of (a) the fixed station, (b) the carrier vehicle and (c) the satellite vehicle include at least one coupling unit adapted for at least one of (a) in-coupling and (b) out-coupling of the higher-frequency currents.

20. The transport system according to claim 16, wherein the drive of the lifting platform is contactlessly supplied with energy.

21. The transport system according to claim 16, wherein the drive of the satellite vehicle is contactlessly supplied with energy.

22. The transport system according to claim 16, wherein, at at least one location, energy is contactlessly transmittable from the main vehicle to at least one primary conductor of at least one shelf of at least one side aisle.

23. The transport system according to claim 16, wherein at least one transmission head is provided for contactless transmission of energy.

24. The transport system according to claim 16, wherein the main vehicle includes a power supply adapted to supply a primary line provided on the main vehicle inductively coupled to a transmission head connected to a terminal box for impedance compensation, which supplies at least one primary line provided in the satellite track section.

25. The transport system according to claim 16, wherein the main vehicle includes a primary line, which, during alignment, is inductively coupleable to a transmission head installed in a floor, which is connected to at least one primary line provided in a shelf via a terminal box for impedance compensation.

26. The transport system according to claim 16, wherein the lifting platform includes a primary line inductively coupleable to a transmission head provided on a shelf during flush alignment of the main vehicle and vertical positioning of the lifting platform, the transmission head connected to at least one primary line provided in a shelf via a terminal box for impedance compensation.

27. The transport system according to claim 26, wherein the primary line includes a transmission head.

28. The transport system according to claim 16, wherein the main vehicle is adapted to energize of the primary conductor of a respective shelf.

29. The transport system according to claim 23, wherein at least one transmission head includes at least one of (a) a U-shaped core, (b) a C-shaped and (c) an E-shaped ferrite core.

30. The transport system according to claim 23, wherein at least one transmission head includes a winding in the form of a flat winding.

31. The transport system according to claim 30, wherein the flat winding is disposed around a middle leg of an E-shaped core.

32. The transport system according to claim 29, wherein legs of the E are shorter than a distance of next nearest legs from each other.

33. The transport system according to claim 16, wherein the primary line includes at least one of (a) feed line and return line and (b) a feed line and an at least partially surrounding profile.
